(19) United States
(12) Patent Application Publication
(10) Pub. No.: US 2005/0084545 A1
(43) Pub. Date: Apr. 21, 2005

(54) Non phytotoxic biocide composition containing tea tree oil and method of production the same

(76) Inventors: Gregory Pipko, Katzrin (IL); Dani Neifeld, Moshav Bney Yehuda (IL); Moshe Reuveni, Katzrin (IL)

Correspondence Address: DANIEL J SWIRSKY, PO BOX 2345, BEIT SHEMESH, 99544, IL

(21) Appl. No.: 10/968,146

(22) Filed: Oct. 20, 2004

(30) Foreign Application Priority Data
Oct. 20, 2003 (IL) IL 158509

(51) Int. Cl. A01N 37/30; A01N 37/00; A01N 65/00

(52) U.S. Cl. 424/727; 514/554; 424/778; 424/769; 424/745; 424/736; 424/742; 514/560

(57) ABSTRACT

A non-phytotoxic biocide composition comprising inter alia alkali or ammonium salts of organic fatty acids forming an emulsion, and terpinen-4-ol oil solubilized in the emulsion. A novel method is disclosed of producing the aforesaid non-phytotoxic biocide, including the steps of admixing alkali or ammonium salts with organic fatty acids so an emulsion is obtained, and admixing terpinen-4-ol oil in the emulsion until full solubilization is obtained.

### CROSS-REFERENCE TO RELATED APPLICATIONS

This application claims priority under 35 U.S.C. 119 from Israel Patent Application No. 158,509, filed Oct. 20, 2003.

### FIELD OF THE INVENTION

The present invention generally relates to a non-phytotoxic biocide composition containing tea tree oil (hereinafter TTO) and to a method of its production.

### BACKGROUND OF THE INVENTION

Tea Tree Oil (hereinafter ‘TTO’) is an essential oil characterized by a broad-spectrum antiseptic activity and is a very effective biocide against bacteria, fungi and insects. TTO is an essential oil distilled from the leaves of the paperbark tree species Melaleuca alternifolia. The tree is indigenous to the moist, sub-tropical coast of northeastern New South Wales and southeast Queensland in Australia, and has evolved its own natural defenses against disease and its own natural repellants against insects.

The major antiseptic active component of the TTO is the Terpinen-4-ol family. The mode of action of TTO on cell target is to damage the pathogen's cell wall and membrane and subsequently to denature the cell constituents. The antiseptic actions of TTO are not impaired in the presence of blood, serum, pus, mucous discharge etc. An acquired immunity of microorganisms to many antibiotics and sulphonamide drugs does not occur with TTO.

Substantial microbiological testing of TTO has established in the literature typical inhibitory concentrations of the oil against a broad spectrum of microorganisms. Nevertheless, its sharp aromatic characteristics eliminate it is use AS IS in humans, animal and field-corps. Many formulations have been suggested in the art, few of them teach its use in emulsions. U.S. Pat. No. 6,464,989 to Dillon for example discloses tea tree oil emulsion formulations at a concentration greater than about 22% on a weight-by-weight basis. The emulsion also contains an emulsifier, wheat germ oil, cocoa butter, beeswax, ozokerite wax, pentaerythritol ether, vitamin E acetate, vitamin A, and vitamin D3. The emulsifier is selected from stearic acid, glyceryl stearate, polyethylene glycol 100 stearate, steareth-21, and steareth-2. This cosmetic formulation is especially adapted to be topically administrated on humans skin, is evidently not suitable for any agricultural utilization.

It is acknowledged in this respect that some TTO-containing compositions suggested in the art are targeted for herbicidal purposes. The highly phytotoxic nature of the TTO is widely used in many commercially available herbicide products. U.S. Pat. No. 5,998,335 to Selga et al. presents one approach for an “knock-down” herbicidal composition effective against mature weeds having, as its sole active ingredient, a combination of (a) pine oil and (b) tea tree oil or eucalyptus oil. As set forth above, the TTO comprises highly volatile and effective ingredients, which kill vegetable cells, microorganisms, insects and other pathogens.

While few effective TTO-containing emulsion biocides have been published in the literature, their harmful side effects were not considered at all. Thus for example, U.S. Pat. No. 5,610,189 to Whiteley discloses a disinfecting composition comprising stable aqueous solutions of (a) a blend of biocide active terpenes from TTO; (b) one or more biocide active surfactants; (c) one or more proton donor type biocides; and (d) a salt of mono, di- or trihydroxy aliphatic or aromatic acid; and U.S. Pat. No. 6,197,305 to Friedman et al. discloses composition for oral hygiene for treating a fungal infection, comprising: a mixture of herbal extracts; (b) a mixture of essential oils such as TTO; and a pharmaceutical carrier; wherein said herbal extracts are each present in an amount of from about 1% to about 10% by weight, and each essential oil is present in an amount of from about 0.2% to about 2.0% by weight.

JP Pat. No. 2,145,502 to Watanabe et al. teaches an agent for controlling crop diseases by means of TTO adapted to the form of a dust or a granular preparation. Those particles in the solid phase are introduced to the object to be treated by means of cloth or paper so that the powder flies off. This approach suffers several drawbacks, i.e., the TTO-containing power is characterized by only a meager wetting properties, its delivery to the crops and the pathogens is very much limited, it is suitable only for a narrow range of applications, i.e., in-house gardening and especially the respectively expensive plants accommodated in flowerpots.

Non-toxic and/or nonphytotoxic organic biocides, especially those containing the effective organic products, such as the TTO-emulsion preparations, which are especially adapted to crop-filed agriculture are thus meeting ever growing industrial need.

### SUMMARY OF THE INVENTION

It is thus the core of the invention to provide a cost effective non-phytotoxic biocide emulsion comprising alkali or ammonium salts of organic fatty acids forming an emulsion; and terpinen-4-ol oil solubilized in said emulsion. This novel non-phytotoxic is characterized by a broad spectrum disinfective activity. Said spectrum is preferably selected from kanacidic, insectecidic, antibiotic, fungicidic, bacteriocidic activities or any mixture thereof.

The organic fatty acids preferably comprising linear or branched alkyl chains of 6<C<22, and more specifically 12<C<18 alkyl chains. Preferably, at least a portion of the organic fatty acid is saturated fatty acid selected among lauric acid, myristic acid, palmitic acid, stearic acid, arahinoic acid, behenic acid, lingocerinic acid or any mixture thereof. Additionally or alternatively, the organic fatty acid is unsaturated fatty acids selected among decenoic acid, dodecenoic acid, palamitinoleic acid, oleic acid, lonoleic acid, undecelenic acid, sorbic acid, recinoleic acid or any mixture thereof. Additionally or alternatively, the organic fatty acid is selected among tall oil acids, naftenic acids, rosin acids and any mixture thereof.

It is also in the scope of the present invention wherein the biocide composition additionally comprising etheric oil. The etheric oil is preferably selected from lavender oil, pine oil, manuka oil, kanuca oil, eucalyptus oil, bergamot oil, clove oil, lemon oil, lemon grass oil, rosemary oil, geranium oil or any mixture thereof. The concentration of the etheric oil is preferably between 0.01% to 5%.

It is also in the core of the present invention wherein the terpinen-4-ol is provided in tea tree oil. The terpinen-4-ol concentration in the tea tree oil is preferably in the range of 20 to 50%. The terpinen-4-ol may comprise inter alia compounds selected from terpinenes, cymenes, pinenes, terpineols, cineole, sesquiterpenes, sequiterpene alcohols or any mixture thereof. The concentration of the terpinen-4-ol is between 0.005% up to 10%. The concentration of the terpinen-4-ol is preferably between 0.05% to 1.0%. The alkali and ammonium salts may comprise at least one compound selected from sodium, potassium and/or ammonium hydroxides, carbonates, bicarbonates or any mixture thereof.

It is another object of the present invention to provide a simple method for producing the non-phytotoxic biocide as defined in any of the above comprising the steps of (A) admixing alkali or ammonium salts with organic fatty acids so an emulsion is obtained; and subsequently (B) admixing terpinen-4-ol oil in said emulsion until full solubilization is obtained.

It is thus in the scope of the present invention wherein the organic fatty acids admixed in the aforementioned step A comprising linear or branched alkyl chains of 6<C<22 and specifically 2<C<18. At least a portion of the organic fatty acid may be saturated fatty acid selected among lauric acid, myristic acid, palmitic acid, stearic acid, arahinoic acid, behenic acid, lingocerinic acid or any mixture thereof. It is acknowledged in this respect that at least a portion of the organic fatty acid may be unsaturated fatty acids selected among decenoic acid, dodecenoic acid, palamitinoleic acid, oleic acid, lonoleic acid, undecelenic acid, sorbic acid, recinoleic acid or any mixture thereof; tall oil acids, naftenic acids, rosin acids or any mixture thereof.

It is also in the scope of the present invention wherein the method defined above additionally comprising the step of admixing etheric oil to the obtained emulsion. The etheric oil may be selected for lavender oil, pine oil, manuka oil, kanuca oil, eucalyptus oil, bergamot oil, clove oil, lemon oil, lemon grass oil, rosemary oil, geranium oil, Phlai Oil, e.g., oil made of Zingiber cassumunae; or any mixture thereof and its concentration is between 0.01% to 5%.

It is also in the scope of the present invention wherein the terpinen-4-ol is provided in tea tree oil. Additionally or alternatively, the terpinen-4-ol concentration in the tea tree oil is in the range of 20 to 50%. Preferably, the terpinen-4-ol admixed to the emulsion comprising inter alia compounds selected from terpinenes, cymenes, pinenes, terpineols, cineole, sesquiterpenes, sequiterpene alcohols or any mixture thereof. The concentration of the terpinen-4-ol admixed to the emulsion may be between 0.005% up to 10% and especially between 0.05% to 1.0%.

It is lastly in the scope of the present invention wherein the alkali and ammonium salts admixed to form the emulsion comprising at least one compound selected from sodium, potassium and/or ammonium hydroxides, carbonates, bicarbonates or any mixture thereof.

### DETAILED DESCRIPTION OF THE INVENTION

The following description is provided, alongside all chapters of the present invention, so as to enable any person skilled in the art to make use of said invention and sets forth the best modes contemplated by the inventor of carrying out this invention. Various modifications, however, will remain apparent to those skilled in the art, since the generic principles of the present invention have been defined specifically to provide biocide compositions containing teat tree oil (hereinafter ‘biocide composition’), and more specifically to provide an effective emulsion containing etheric components obtained non-phytotoxic biocide compositions.

This biocide product comprising tea tree oil and a water emulsion; wherein the emulsifier is a water solution of a reaction product of a high molecular weight organic fatty acid and an alkali or ammonium compound.

The term ‘tea tree’ (i.e., TT) is especially referring hereinafter to Melaleuca alternifolia known in the common name “tea tree.” More generally, the term is referring to any of the laurel tree family, unusual variety indigenous to the east coast of Australia. The term ‘tea tree’ (i.e., TT) is more generally referring hereinafter to any tree of the tea tree family and to other Australian trees or plants of other locations provided for useful essential oil as such as those obtained from tree of the family of the Eucalyptus, particularly Eucalyptus citriodora, Eucalyptus globules, Eucalyptus radiata; and other plants, such as niaouli oils (Melaleuca viridiflora)—Australian Niaouli, also known as broad-leaved paperbark; Australian Blue Cypress; Kunzea ambigua, also known as “White cloud” or “White kunzea”; Lavandula angustifolia (e.g., Bridestowe), known also as Tasmanian Lavender; Western Australian Sandalwood; White (e.g., Jade) Cypress—Essential oil of Callitris columellaris/glaucophylla; Citrus bergamia; Mentha piperita; Rosmarinus officinalis; Pine oils; Essential Oil Blends, such a blends of Melaleuca alternifolia, Melaleuca quinquenervia nerolidol/linalool, and Callitris intratropica etc.

The term ‘tea tree oil’ (i.e., TTO) is generally referring hereinafter to any water miscible and water immiscible ingredient of the TT as defined specifically and/or broadly above.

Particularly, the term TTO is referring to terpinen-4-ol type oils consisting chiefly of terpinenes, cymenes, pinenes, terpineols, cineole, sesquiterpenes, and sequiterpene alcohols. The term TTO is also referring to any naturally obtained or chemically synthesized of purified composition comprising terpinen-4-ol oils, 29-45%; γ-terpinene, 10-28%, α-terpinene, 2.7-13%; 1,8,-cineole, 4.5-16.5%, and various terpenes, 1-5% selected yet not limited to α-pinene, limonene, ρ-cymene and terpinolene. This term is also referring to Phlai Oil, e.g., an essential oil obtained from rhizome Zingiber cassumunae.

The term ‘emulsion’ is referring hereinafter to any water in oil (W/O); oil in water (O/W); W/O/W and/or O/W/O phases comprising the TTO inside, outside or at the surface of aggregates, vesicles, micelles, reversed micelles, nano-emulsions, micro-emulsion, liposomes or in any combination thereof.

The term ‘emulsifier’ is referring hereinafter to any material or molecule provided as a polymer, oligomer or monomer and is nonionic, anionic or cationic detergent and/or surfactant. The emulsifier is preferably comprises of both lypophilic and hydrophilic portions, such as in saturated or non-saturated long chain alkyl comprising at least one polar or charged atom.

The terms ‘biocide’ is specifically referring hereinafter to consisting non-phytotoxic biocides selected from yet not limited to miticides, insecticides, algaecides, bactericides, fungicides or any combination thereof.

The non-phytotoxic biocide compositions according to the present invention are proved to be Environmentally friendly: its principal constituent; tea tree oil and/or terpen-4-ol, does not pollute. The compositions are extremely effective biocide and characterized by a wide spectrum, no-gap biocide: sanitizing disinfectant effective against all bacteria, viruses, fungi and algae, a simple ‘one-stop’ approach. Those products are proved to destroys biofilm and have a long term effectiveness. It is simple application, and simple to monitor: product concentrations can be easily and accurately measured and know to be Safe: in its diluted state it does not cause irritation to the skin, eyes, and mucous membranes, nor is it toxic or have any known carcinogenic or mutagenic effects.

This biocide composition consists in a biocide emulsion comprising TTO and a water emulsion in which the emulsifier is a water solution of a reaction product of a high molecular weight organic fatty acid and an alkali or ammonium compound.

It is one embodiment of the present invention wherein the aforementioned biocide composition additionally comprising etheric oils, selected yet not limited to at least one of the group of lavender oil, pine oil, manuka oil, kanuca oil, eucalyptus oil, bergamot oil, clove oil, limonen oil etc.

It is another embodiment of the present invention wherein the aforementioned high molecular weight fatty acid, fatty acids or a mixture of said acids is saturated, unsaturated or comprising a combination of the two, one or all referred hereto in the short term ‘high molecular weight fatty acid’.

It is another embodiment of the present invention wherein the aforementioned high molecular weight fatty acid comprising linear or branched alkyl chains of C>6 to C<22, especially the range from C>12 to C<18 atoms per molecule. It is in the scope of the present invention wherein those high weight fatty acids are non-limitingly selected from at least one of the following groups:
i. tall oil acids, naftenic acids, rosin acid or any combination thereof;
ii. saturated fatty acids selected from the group of lauric acid, myristic acid, palmitic acid, stearic acid, arahinoic acid, behenic acid, lingocerinic acid or any combination thereof,
iii. unsaturated fatty acids selected from the group of decenoic acid, dodecenoic acid, palamitinoleic acid, oleic acid, lonoleic acid, undecelenic acid, sorbic acid, recinoleic acid or any combination of thereof.

According to yet another embodiment of the present invention, those acids are treated with alkali hydroxides, carbonates, bicarbonates or any combination thereof to obtain a salt. Additionally or alternatively, the hereto-defined acids are admixed with sodium, potassium or ammonium compounds, e.g., hydroxides, carbonates, bicarbonates or any combination thereof to obtain a salt.

According to yet another embodiment of the present invention, the emulsion comprises from 0.01% to 10%, preferably from 0.1% to 1.5% TTO and from 0.02% to 10%, preferably between 0.1% to 1% of the aforementioned salt, wherein the remainder being water as defined above.

According to yet another embodiment of the present invention, the emulsion additionally comprises of etheric oil. The concentration of said etheric oil is between 0.01% to 5%, preferably 1% to 5%.

According to yet another embodiment of the present invention, the emulsion is prepared by admixing a water solution comprising alkali hydroxide, carbonate or bicarbonate with a liquid solution of organic acid; subsequently admixing a TTO or a TTO-etheric acid mixture. Said admixing step is provided in the manner homogeneous composition is obtained.

Freshly prepared salts solution in water give good emulsification of TTO in a wide concentration range. However, it is possible to use industrially prepared alkali salts of organic acid in powder or in granulated form to dissolve the salt obtained in hot water and to use the received solutions for the emulsification of the TTO.

The TTO containing biocides composition according to the present invention are useful for treating the pathogens located in the flowers, fruits, leaves, roots, tubers, tubers, etc. without alarming the plant itself.

It is also in the scope of the present invention to use the aforesaid TTO containing biocides useful for the management of pathogens in fish, especially in treating Saprolegnia infections. Moreover, said TTO compositions are useful as malachite green replacements.

In order to understand the invention and to see how it may be implemented in practice, a plurality of preferred embodiments will now be described, by way of non-limiting example only, with reference to the following examples, wherein all percentages are denoted for weight percents.

Potato scab is a common tuber disease that occurs throughout the potato growing regions of the world. Although scab does not usually affect total yields, significant economic losses result from reduced marketability of the tubers. Sterptomyces scabies as other pathogens infects young developing tubers through the lenticels and occasionally through wounds. Initial infections result in superficial reddish-brown spots on the surface of tubers. As the tubers grow, lesions expand, becoming corky and necrotic. The pathogen sporulates in the lesion, and some of these spores are shed into the soil or reinfest soil when cull potatoes are left in the field. The pathogen survives in lesions on tubers in storage, but the disease does not spread or increase in severity. Inoculum from infected seed tubers can produce disease on progeny tubers the next season.

Infected tubers of potato (Solanum tuberosum) were treated therefore with the biocides according to the present invention by immersing some ten tubers in 0.5% to 2.0% TTO-emulsions for two minutes. Subsequently, the treated plants were dried in ambient conditions, and the pathogens viability was analyzed by sporulation and/or growing of the pathogens on selective nutrient media.

### EXAMPLE 1

300 g of naftenic acid are mixed with 160 g of 125% solution of HaOH in water for 60 minutes at 70° C. 316 g TTO is admixed to the reaction product obtained by a means of a contentious stirring until full homogenization is obtained. From the composition obtained, which contains 50% TTO, a stable TTO O/W emulsion is prepared by contentiously admixing of water, in the manner an emulsion comprising from 0.001 % to 49.9% of oil.

### EXAMPLE 2

Into a 25% water solution of 300 g KHCO₃, some 400 g of melted stearic acid is admixed at 75° C. for 30 min. Subsequently; a mixture of 500 g of TTO and 200 g of lavender oil is admixed to the alkali admixture until a full homogenization is obtained. From the composition obtained, a stable TTO O/W emulsion comprising from 0.001% to 49.9% of etheric oil is obtained.

### EXAMPLE 3

30 g of Na₂CO₃ were dissolved in 100 g of water at 50° C. for 30 min. This solution was admixed with 120 g of tall oil acid, comprising 25% of rosin acid for additional 30 min. The obtained mixture was dissolved in 500 g of TTO until a homogenized solution is obtained. A plurality of stable TTO-containing emulsions was subsequently obtained.

### EXAMPLE 4

280 g of oleic acid was admixed with 85 g of a 20% ammonia solution at 60° C. 400 g of TTO was admixed until a homogenized solution was obtained.

### EXAMPLE 5

30 g of Na₂CO₃ were dissolved in 100 g of water at 50° C. for 30 min. This solution was admixed with 120 g of tall oil acid, comprising 25% of rosin acid for additional 30 min. The obtained mixture was dissolved in 250 g of TTO and 250 g of pine oil until a homogenized solution is obtained. A plurality of stable TTO-containing emulsions was subsequently obtained.

TABLE 1
An average effect of various biocides
comprising TTO-containing emulsions.
Colonies of S. scabies (cfu per gram)
were counted under the microscope
wherein average number of triplicates
of ten infected potato tubers is hereto
present.

| | Bacteria | |
|---|---|---|
| Treatment | cfu/gr | Inhibition % |
| Control | 241.6 | — |
| 0.5% | 10.6 | 96 |
| 2.0% | 12.3 | 95 |

### EXAMPLE 6

The effect of the compositions defined above was tested in systems comprising aphids of various types. For example, those TTO containing compositions according to the present invention (i.e., TTO Composition A and B) where provided most effective in treating melon plants contaminated by green aphids. The melon plants were not affected or attacked by the said treatment.

TABLE 2
An average effect of various biocides
comprising TTO-containing emulsions on
treating melon plants contaminated by green aphids

| | Aphids | Aphids No. | Aphids No. | Aphids No. |
|---|---|---|---|---|
| Treatment | No. T₀ | T_{1 day} | T_{3 days} | T_{7 days} |
| Control | 156 | 161 | 103 | 98 |
| TTO Composition A | 197 | 52 | 22 | 13 |
| TTO Composition B | 274 | 20 | 5 | 3 |

### EXAMPLE 7

The effect of the compositions defined above was tested in systems comprising mites of various types. For example, those TTO containing compositions according to the present invention (i.e., TTO Composition A and B) where provided most effective in treating cucumbers, pepper and pumpkin plants contaminated by mites. All the aforementioned plants were not affected or attacked by the said treatment. The treatment included spraying the said compositions at the beginning of the experiments and after three consecutive days.

TABLE 3
An average effect of various biocides
comprising TTO-containing emulsions on
treating cucumbers, pepper and pumpkin
plants contaminated by mites.

| | Mites No. | Mites No. | Mites No. |
|---|---|---|---|
| Treatment | T₀ | T*_{3 days} | T*_{5 days} |
| Control | 10 | 8 | 8 |
| TTO Composition A 1.0% | 10 | 2 | 0 |
| TTO Composition B 0.5% | 10 | 0 | 0 |

*Number of mites counted three and five days post treatment

### EXAMPLE 8

The effect of the compositions defined above was tested in systems comprising larva of Lepidifetera and/or Pectinophora Gossyiella Saunders. For example, those TTO containing compositions according to the present invention where provided most effective in treating cotton plants contaminated by this larva, especially by avoiding penetration of the larva into the plant, whereat control corps that was not initially sprayed by the TTO-compositions was significantly infected by the larva. Moreover, the cotton plants were not affected or attacked by the said treatment.

The present invention also provides a simple and novel method for producing the non-phytotoxic biocide as defined in any of the above. The method is essentially comprise two steps, yet other sub-reactions are possible: (A) admixing alkali or ammonium salts with organic fatty acids so an emulsion is obtained; and subsequently (B) admixing terpinen-4-ol oil in said emulsion until full solubilization is obtained. The mixing is provided by either stirring the solutions in a magnetic or mechanical stirrer or by means of any commercially available mechanical or ultrasonic homogenizer. The mixing is provided in a board spectrum of temperature, e.g., ambient temperature and/or at 25 to about 75° C. The mixing time is from 2 minutes to about 30 min., depend on the mixing velocity, admixed volume, admixing means, admixed compositions and temperature.

### EXAMPLE 9

The effect of TTO containing biocides for the management of pathogens in fish was studied. More specifically, the susceptibility of Saprolegnia to this novel disinfectant and antifungal agent was tested in both a both agar-dilution test, and apply the known NCCLS micro- and macro- broth dilution tests known in the art of medical mycology for the susceptibility tests.

Composition A: 10,000 ppm induced total inhibition; 1,000 ppm induced 80% inhibition in comparison to control; 100 ppm induces significant damage to the hyphae, and about 50% inhibition; 10 ppm were non effective at all.

Composition B: 1,000 ppm induced total inhibition; 100 ppm induced 80% inhibition; and 10 ppm induced 50%; 1 ppm was non-effective.

### EXAMPLE 10

The effect of the compositions defined above was tested for proving the effectively of aforesaid TTO-composition against Helminthosporium solani; Rhizoctonia solani, and Sterptomyces scabies in potatoes. Infected potato tubers were immersed in said compositions (0.5, 1.0 and 2.0%) for two minutes:

TABLE 4
An average disinfecting effect of
various biocides comprising TTO-containing
emulsions on treating potato tubers
contaminated by various bacteria and fungi

| | Sterptomyces | | |
|---|---|---|---|
| System | scabies | Helminthosporium solani | Rhizoctonia solani |
| Control | 0 | 0 | 0 |
| 0.5% | 57 | 7.4 | 100 |
| 1.0% | 30 | 28.4 | 100 |
| 2.0 | 54 | 42.9 | 100 |

*Percent inhibition as related to control

### EXAMPLE 11

The effect of the TTO-compositions defined above was tested to prove a selective biological control of fungal and bacterial plant pathogens such that the mortality of biological control agent (namely Orius laeuvigatus) is respectively low. Hence, applying a direct spraying of the aforesaid TTO-emulsion (1%) on Orius laeuvigatus on pepper leaves according to the IOBC regulations was found harmless (mortality is lower than 30%).

1. A non-phytotoxic biocide composition comprising:
a. alkali or ammonium salts of organic fatty acids forming an emulsion; and
b. terpinen-4-ol oil solubilized in said emulsion.

2. The biocide according to claim 1, wherein the organic fatty acids comprising linear or branched alkyl chains of 6<C<22.

3. The biocide according to claim 1, wherein the organic fatty acids comprising linear or branched alkyl chains of 12<C<18.

4. The biocide according to claim 1, wherein at least a portion of the organic fatty acid is saturated fatty acid selected among lauric acid, myristic acid, palmitic acid, stearic acid, arahinoic acid, behenic acid, lingocerinicacd or any mixture thereof.

5. The biocide according to claim 1, wherein at least a portion of the organic fatty acid is unsaturated fatty acids selected among decenoic acid, dodecenoic acid, palamitinoleic acid, oleic acid, lonoleic acid, undecelenic acid, sorbic acid, recinoleic acid or any mixture thereof.

6. The biocide according to claim 1, wherein at least a portion of the organic fatty acid is selected among tall oil acids, naftenic acids, rosin acids and any mixture thereof.

7. The biocide according to claim 1, additionally comprising etheric oil.

8. The biocide according to claim 7, wherein the etheric oil is selected for lavender oil, pine oil, manuka oil, kanuca oil, eucalyptus oil, bergamot oil, clove oil, lemon oil, lemon grass oil, rosemary oil, geranium oil or any mixture thereof.

9. The biocide according to to claim 7, wherein the concentration of the etheric oil is between 0.01% to 5%.

10. The biocide according to claim 1, wherein the terpinen-4-ol is provided in tea tree oil.

11. The biocide according to claim 10, wherein the terpinen-4-ol concentration in the tea tree oil is in the range of 20 to 50%.

12. The biocide according to claim 1, wherein the terpinen-4-ol comprising inter alia compounds selected from terpinenes, cymenes, pinenes, terpineols, cineole, sesquiterpenes, sequiterpene alcohols or any mixture thereof.

13. The biocide according to claim 1, wherein the concentration of the terpinen-4-ol is between 0.005% up to 10%.

14. The biocide according to claim 1, wherein the concentration of the terpinen-4-ol is between 0.05% to 1.0%.

15. The biocide according to claim 1, wherein the alkali and ammonium salts comprising at least one compound selected from sodium, potassium and/or ammonium hydroxides, carbonates, bicarbonates or any mixture thereof.

16. The biocide according to claim 1, characterized by a non-phytotoxic borad spectrum activity disinfective activity selected from kanacidic, insectecidic, antibiotic, fungicidic, bacteriocidic activities or any mixture thereof.

17. The biocide according to claim 1, additionally comprising tetracyclo-quinolizindine alkaloids, matrine and/or oxymatrine.

18. The biocide according to claim 17, wherein the alkaloids are extracted from the group consisting of Sophora japonica, Sophora subprostrata, Sophora alopecuroides or any combination thereof.

19. The emulsion according to claim 1, substantially as herein described with reference to the examples

20. A method of producing the non-phytotoxic biocide composition comprising alkali or ammonium salts of organic fatty acids forming an emulsion and terpinen-4-ol oil solubilized in said emulsion, comprising:
a. admixing alkali or ammonium salts with organic fatty acids so an emulsion is obtained; and,
a. admixing terpinen-4-ol oil in said emulsion until full solubilization is obtained.

21. The method according to claim 20, wherein the organic fatty acids comprising linear or branched alkyl chains of 6<C<22.

22. The method according to claim 20, wherein the organic fatty acids comprising linear or branched alkyl chains of 12<C<18.

23. The method according to claim 20, wherein at least a portion of the organic fatty acid is saturated fatty acid selected among lauric acid, myristic acid, palmitic acid, stearic acid, arahinoic acid, behenic acid, lingocerinic acid or any mixture thereof.

24. The method according to claim 20, wherein at least a portion of the organic fatty acid is unsaturated fatty acids selected among decenoic acid, dodecenoic acid, palamitinoleic acid, oleic acid, lonoleic acid, undecelenic acid, sorbic acid, recinoleic acid or any mixture thereof.

25. The method according to claim 20, wherein at least a portion of the organic fatty acid is selected among tall oil acids, naftenic acids, rosin acids and any mixture thereof.

26. The method according to claim 20, additionally comprising the step of admixing etheric oil to the obtained emulsion.

27. The method according to claim 26, wherein the etheric oil is selected for lavender oil, pine oil, manuka oil, kanuca oil, eucalyptus oil, bergamot oil, clove oil, lemon oil, lemon grass oil, rosemary oil, geranium oil or any mixture thereof.

28. The method according to claim 26, wherein the concentration of the etheric oil admixed to the emulsion is between 0.01% to 5%.

29. The method according to claim 20, wherein the terpinen-4-ol is provided in tea tree oil.

30. The method according to claim 29, wherein the terpinen-4-ol concentration in the tea tree oil is in the range of 20 to 50%.

31. The method according to claim 20, wherein the terpinen-4-ol admixed to the emulsion comprising inter alia compounds selected from terpinenes, cymenes, pinenes, terpineols, cineole, sesquiterpenes, sequiterpene alcohols or any mixture thereof.

32. The method according to claim 20, wherein the concentration of the terpinen-4-ol admixed to the emulsion is between 0.005% up to 10%.

33. The method according to claim 20, wherein the concentration of the terpinen-4-ol admixed to the emulsion is between 0.05% to 1.0%.

34. The method according to claim 20, wherein the alkali and ammonium salts admixed to form the emulsion comprising at least one compound selected from sodium, potassium and/or ammonium hydroxides, carbonates, bicarbonates or any mixture thereof.

35. The method according to claim 20, additionally comprising admixing tetracyclo-quinolizindine alkaloids, matrine and/or oxymatrine.

36. The method according to claim 35, wherein the alkaloids are extracted from the group consisting of Sophora japonica, Sophora subprostrata, Sophora alopecuroides or any combination thereof.
